(19) United States
(12) Patent Application Publication
(10) Pub. No.: US 2012/0057763 A1
(43) Pub. Date: Mar. 8, 2012

(54) METHOD FOR RECOGNIZING THE IDENTITY OF USER BY BIOMETRICS OF PALM VEIN

(76) Inventors: Shi-Jinn Horng, Taipei City (TW); Tsung-Huai Mou, Taipei City (TW)

(21) Appl. No.: 13/164,250

(22) Filed: Jun. 20, 2011

(30) Foreign Application Priority Data
Sep. 3, 2010 (TW) 099129782

(51) Int. Cl. G06K 9/00

(52) U.S. Cl. 382/115

(57) ABSTRACT

The present invention discloses an identity recognition method for recognizing the biometric features of a predetermined palm by biometric features stored in a database. The method of the invention includes the following steps of: (S1) forming an initial image; (S2) determining if the initial image matches the image of the palm, if yes, process step (S3); (S3) applying a convolution process to the initial image; (S4) capturing a plurality of biometric features by Scale Invariant Feature Transformation (SIFT); and (S6) comparing the plurality of the biometric features of the initial image to the biometric features stored in the database.

### BACKGROUND OF THE INVENTION

1. Field of the Invention

The present invention relates to an identity recognition method, and more particularly, to a method for recognizing the identity of the user by biometrics of the palm vein.

2. Description of the Prior Art

Biometrics plays an increasingly important role in current society. The application of biometric technology can be seen from cash machines, access control systems, notebook computers to flash drives.

In the biometrics field, the palm vein recognition is an emerging research priority. The palm vein has more information than fingerprints or palm prints and can get a better recognition rate. The recognition rate is almost equivalent to the recognition rate of the biometric system utilizing the iris technology. Coupling with the advantage which cannot be imitated, the palm vein recognition gradually becomes the focus in the biometrics field. In particular, in the view of the growth rate, the palm vein recognition technology can be expected to compete on equal terms with other biometric technology. Unfortunately, the current research and development related to palm vein are rare.

The prior finger and palm vein recognition research usually captures the vein image first, selects the required area image after preprocessing the vein image, and finds the end points and crossing points of the image as a feature point after applying the binarization and thinning. However, for real-time recognition system, said method is excessively sensitive to the change of environment. The result of the said method will be extremely different if the hand just moves a little bit. For this reason, said method is not suitable for application.

Therefore, how to design a biometric system with good recognition result, for providing stable and sufficient feature points, is an urgent and important issue in the current.

In view of the prior palm vein recognition methods in practical application cannot provide stable and sufficient feature points, the present invention discloses a biometric method with good recognition result for enhancing the efficiency of biometric method.

### SUMMARY OF THE INVENTION

In view of this, one scope of the present invention is to provide an identity recognition method. The identity recognition method utilizes a special recognition to enhance the efficiency of the identity recognition system.

In the embodiment of the present invention, the present invention discloses an identity recognition method, for recognizing a plurality of biometric features of a predetermined palm by a set of biometric features stored in a database, comprising the following steps of: (S1) forming an initial image; (S2) determining if the initial image matches the image of the predetermined palm, if yes, process step (S3); (S3) applying a convolution process to the initial image; (S4) capturing a plurality of biometric features from the initial image by Scale Invariant Feature Transformation (SIFT); and (S6) comparing the plurality of the biometric features of the initial image to the set of biometric features stored in the database.

In actual practice, the step (S1) comprises the following substeps of: (S11) irradiating a light of 700 to 1400 nanometer wavelength to the predetermined palm; and (S12) receiving the light from the predetermined palm and utilizing the light to build the initial image.

Moreover, the step (S2) comprises the following substeps of: (S22) framing a rectangular part from the initial image; (S24) marking a plurality of scan lines in vertical and horizontal directions within the rectangular part; (S26) calculating a plurality of points passed by the plurality of scan lines, wherein each point comprises a gray value, an accumulated value is increased if the gray value is larger than a gray threshold, the initial image is determined to a palm image if the accumulated value satisfies a specific condition; and (S28) reapplying (S1) if the initial image is different from the palm image.

The step (S3) further comprises the following substep of: (S32) the convolution process comprises a Gabor filtering process or a Histogram Equalization process.

In addition, in actual practice, the step (S4) further comprises the following substeps of: (S42) detecting an extremum in a scale space; (S44) selecting a feature point; (S46) determining the direction of the feature point; and (S48) building a describing vector of the feature point. Moreover, the substep (S42) further applies Gaussian Blur or Difference of Gaussian to the initial image for detecting the extremum of the scale space.

In addition, the present invention further comprises the step (S7) determining if a matching value of the plurality of the biometric features of the initial image to the set of biometric features stored in the database is larger than a matching threshold, if yes, recognition succeeds; and (S8) if the matching value of the plurality of the biometric features of the initial image to the set of biometric features stored in the database is not larger than the matching threshold, recognition fails. In actual practice, the initial image is a palm vein image.

In summary, the present invention discloses an identity recognition method, and particularly emphasizes on a biometric method by palm vein. The method applies a convolution process to the initial image, utilizes Scale Invariant Feature Transformation (SIFT) to transform the captured image to a set of feature points and calculates the similarity through the set of feature points. More particularly, the feature points transformed by SIFT have a considerable resistance to the scale variation and rotation respectively, are able to resist part of the illuminance variation of image and the interference of noise, and enhances the accuracy of the identity recognition method of the present invention.

On the advantages and the spirit of the invention, it can be understood further by the following invention descriptions and attached drawings.

### BRIEF DESCRIPTION OF THE APPENDED DRAWINGS

FIG. 1 is a flow diagram of an identity recognition method of an embodiment of the invention.

FIG. 2 is a schematic diagram of a describing vector of an embodiment of the invention.

FIG. 3 and FIG. 4 are schematic diagrams of an image similarity calculation flow of an embodiment of the invention.

FIG. 5 and FIG. 6 are schematic diagrams of the experimental data of an identity recognition method of an embodiment of the invention.

FIG. 7 is a schematic diagram of the comparison between the prior art and the present invention.

### DETAILED DESCRIPTION OF THE INVENTION

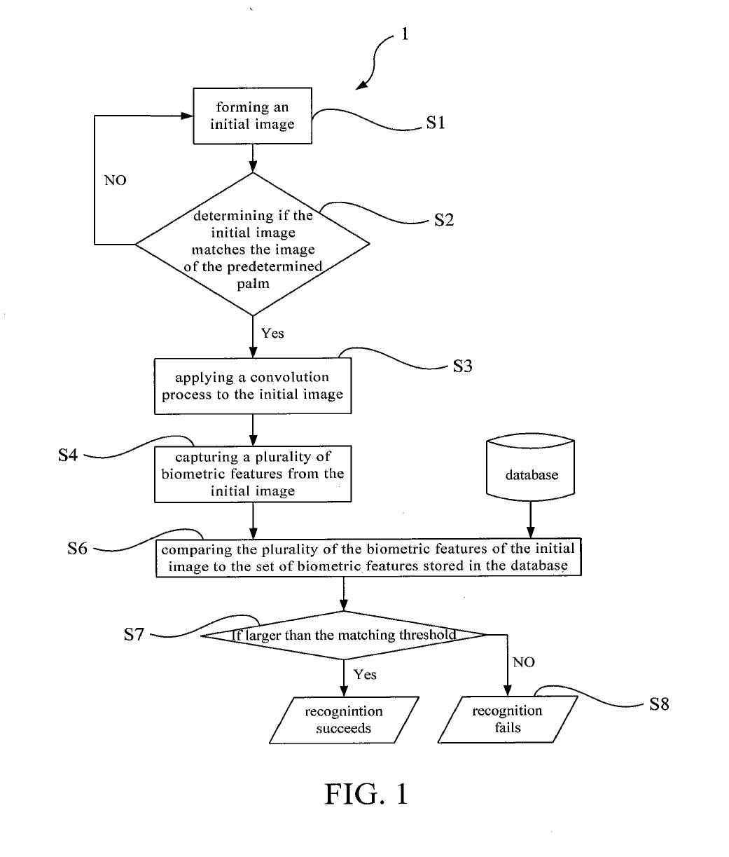

One scope of the present invention is to provide an identity recognition method. Please refer to FIG. 1. FIG. 1 is a flow diagram of an identity recognition method of an embodiment of the invention.

As shown in FIG. 1, the present invention discloses an identity recognition method 1, for recognizing a plurality of biometric features of a predetermined palm by a set of biometric features stored in a database, comprising the following steps of: (S1) forming an initial image; (S2) determining if the initial image matches the image of the predetermined palm, if yes, process step (S3); (S3) applying a convolution process to the initial image; (S4) capturing a plurality of biometric features from the initial image by Scale Invariant Feature Transformation (SIFT); and (S6) comparing the plurality of the biometric features of the initial image to the set of biometric features stored in the database.

In the step (S1), in the embodiment of the present invention, the present invention utilizes an image capture module, such as a combination of a near-infrared camera, a filter, an image capture card and a near-infrared light source, to form the initial image. In general, a light whose wave length is between 700 nm and 1400 nm is infrared light. The light is easily absorbed by the red blood cells without oxygen, which means the red blood cells of the vein, when the light irradiates the human body. As the result, the infrared light is capable of forming a black line clearly in an image. Therefore, the image capture module utilizes the near-infrared light source to irradiate a palm of user, and utilizes the near-infrared camera to take the image reflected from the palm or through the palm for getting the information of the vein, and utilizes the vein to be the feature of recognition.

In the embodiment of the present invention, the initial image is a palm vein image, wherein the initial image can be captured by the image capture card.

The step (S2) of the method 1 of the present invention is that determining if the initial image matches the image of the predetermined palm, if yes, process step (S3). Moreover, the step (S2) further comprises the following substeps of: (S22) framing a rectangular part from the initial image; (S24) marking a plurality of scan lines in vertical and horizontal directions within the rectangular part; and (S26) calculating a plurality of points passed by the plurality of scan lines, wherein each point comprises a gray value, an accumulated value is increased if the gray value is larger than a gray threshold, the initial image is determined to a palm image if the accumulated value satisfies a specific condition.

In the step (S2), the method of the present invention translates the image to a image processing module after the image capture module takes the image, and the image processing module determines if the type of the image matches an palm image. If yes, the image processing module applies the following process. If no, that means the image processing module determines the initial image is different from the palm image, the present invention reapplies the step (S1).

In actual practice, the palm image is brighter than normal environment due to the reflection. In the embodiment of the present invention, for determining if the initial image matches the image of the predetermined palm, the image processing module applies the substep (S22), framing a rectangular part from the initial image, the substep (S24), marking a plurality of scan lines in vertical and horizontal directions within the rectangular part, and then applies the substep (S26), calculating a plurality of points passed by the plurality of scan lines, wherein each point comprises a gray value, an accumulated value is increased if the gray value is larger than a gray threshold, the initial image is determined to a palm image if the accumulated value satisfies a specific condition. In the embodiment of the present invention, the gray threshold of the gray value of the points passed by the plurality of scan lines is 75, and the specific condition is that the accumulated value accumulates more than 98% of the plurality of points passed by the plurality of scan lines and the average of the gray value is between 110 and 150. However, said data is not necessary for the present invention, the data is able to adjust by the actual situation.

The step (S3) of the method 1 of the present invention is that applying a convolution process to the initial image, that means applying a preprocess to the initial image for strengthening the feature of the initial image. The image processing module applies a strengthening process to the initial image if the image processing module determines that the initial image is similar to the image of the predetermined palm. In the embodiment of the present invention, the method of strengthening process is to apply the convolution process to the initial image, wherein the convolution process comprises a Gabor filtering process or a Histogram Equalization process. The Histogram Equalization is able to enhance the contrast of the image, for making the image of vein clearer. Moreover, the said image processing module comprises a Gabor filter, for strengthening the texture of the palm image. The Gabor filter is capable of strengthening the information of the texture of various angles respectively, making the usable feature of the palm increase.

The step (S4) of the method 1 of the present invention is that capturing a plurality of biometric features from the initial image by Scale Invariant Feature Transformation (SIFT). The process of Scale Invariant Feature Transformation (SIFT) is used to transform the image to a plurality of scale invariant feature points with feature description.

In the embodiment of the present invention, the process of Scale Invariant Feature Transformation comprises the following substeps of: (S42) detecting an extremum in a scale space; (S44) selecting a feature point; (S46) determining the direction of the feature point; and (S48) building a describing vector of the feature point.

In the embodiment of the present invention, the substep (S42) is that detecting an extremum in a scale space, further comprises the substep of (S422) applying Gaussian Blur or Difference of Gaussian to the initial image for detecting the extremum of the scale space. For the purpose of getting a plurality of stable features in various scale spaces, the embodiment of the present invention utilizes two methods, difference of Gaussian and building an image pyramid of scale space, for finding all of the extremums in various scales as possible and achieving the effect of resisting the scale variation.

The substep (S44) is that selecting a feature point, that means deleting the point which is bad contrast or at the margin through a found candidate feature point by further selecting. The selected feature point is not only less and faster at matching, but also stronger and more stable.

The substep (S46) is that determining the direction of the feature point, the substep of the present invention requires calculating an orientation and a gradient. Due to the present invention gives the direction to the feature point, the present invention rotates the image to the direction similar to the feature point, makes the corresponding feature point build a describing vector at the direction similar to the feature point, and makes the feature point achieve the rotation invariant.

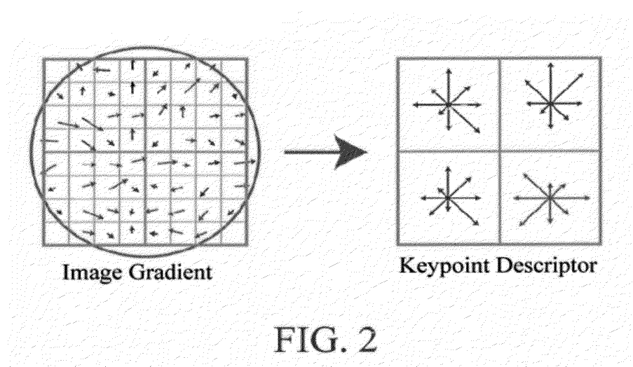

Please refer to the FIG. 2. FIG. 2 is a schematic diagram of a describing vector of an embodiment of the invention. The substep (S48) is that building a describing vector of the feature point. In the embodiment of the present invention, the method of the present invention discloses the process of transforming the image gradient to the keypoint descriptor. For building the describing vector of the feature point, the present invention rotates the image major axis first, makes the direction similar to the major direction of the feature point, selects a plurality of pixels within 16×16 as the feature point to be the center, adds a gaussian function whose scale is 0.5σ as weight, divides the plurality of pixels into 16 subwindows within 4×4, and calculates the orientation histogram of each subwindow in accordance with the method of the previous step. In the substep, every histogram has 8 zones, the describing vector of each feature point has 128 dimensions as 45 degrees to be the unit. Moreover, the said parameters are able to adjust for requirement.

The step (S6) is that comparing the plurality of the biometric features of the initial image to the set of biometric features stored in the database.

The said step is able to transform an image to a plurality of feature point sets with 128 dimensions. And then, said step is able to apply a similarity computation. It means to compare the plurality of scale invariant feature points and the describing vectors to the palm data stored in the database for recognition the identity of the image provider. For the purpose of comparing the feature points efficiently, the palm data stored in the database can build an information structure of k-dimensional tree, and increase the speed of search by a Best-Bin First algorithm.

The Best-Bin First algorithm is able to decrease a lot of time of searching the k-dimensional tree. For the purpose of further improving the efficiency and reducing the redundant comparison, the comparison for large amounts of data will terminate if the number of comparing times over a specified number. Though the comparison does not find any matching point, the comparison still terminates to prevent wasting times at unnecessary comparing. In the embodiment of the present invention, the specified number is 200.

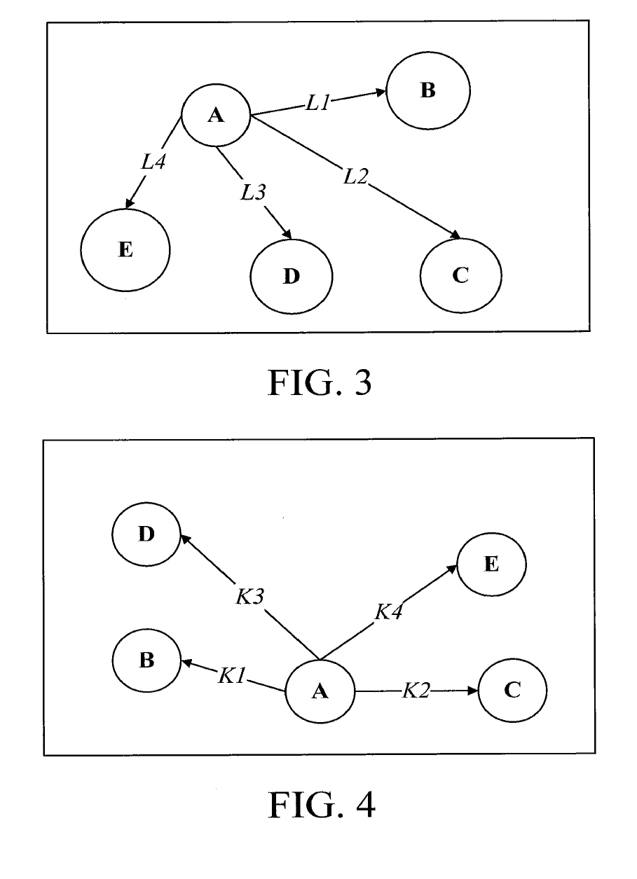

Please refer to FIG. 3 and FIG. 4. FIG. 3 and FIG. 4 are schematic diagrams of an image similarity calculation flow of an embodiment of the invention. After matching the feature point, the result is a point set of the matched feature point from the initial image and an image stored in the database, not a similarity of the initial image and the image stored in the database. For the purpose of calculating the similarity of the initial image and the image stored in the database, the present invention calculates the distance similarity from the points of the initial image and the image stored in the database as a basis for recognition. The present invention takes the first point in the order of matching as the base, and measures the distance between this point and the other points in the coordinate.

In actual practice, if there are n matching points on the initial image and the image stored in the database, the distance between the base point and the other points of FIG. 3 will be defined as Lt, the distance between the base point and the other points of FIG. 4 will be defined as Kt, then the distance similarity d of the two point sets will he defined as

$$d = {\sum }_{i = 1}^{n - 1} \frac{Li}{Ki}$$

According to the distance similarity, the present invention is capable of matching and finding the most similar image. However, if the matching points of the initial image and the image stored in the database are too less, the similarity will be different with the actual result too much. For example, the present invention only gets two matching points after comparing the initial image to the image stored in the database, the distance similarity at this time cannot response to the actual similarity. Therefore, after finding the matching point, the image with less than 5 matching points is not calculated the similarity and set the similarity as 0 for increasing the speed of matching and strengthening the comparing result.

Moreover, in the embodiment of the present invention, the method 1 of the present invention further comprises the step (S7) and the step (S8). The step (S7) is that determining if a matching value of the plurality of the biometric features of the initial image to the set of biometric features stored in the database is larger than a matching threshold, if yes, recognition succeeds. The step (S8) is that if the matching value of the plurality of the biometric features of the initial image to the set of biometric features stored in the database is not larger than the matching threshold, recognition fails.

In the identity recognition method of the present invention, False Accept Rate (FAR) and False Reject Rate (FRR) are used for estimating the quality. FAR is the rate of the illegal user received by the system; FRR is the rate of the legal user received by the system.

In the embodiment of the present invention, the present invention captures the palm vein images of 1,000 people, wherein 746 people are male and 254 people are female, the present invention captures 4 images from each person, the total number of the images captured by the present invention is 4,000.

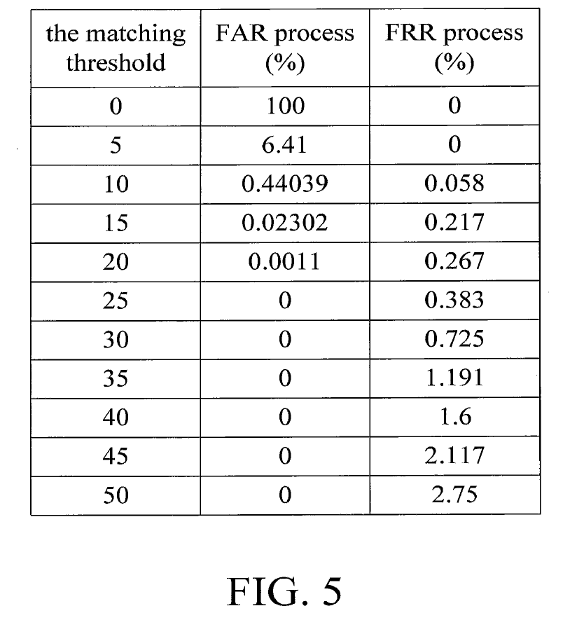

Please refer to FIG. 5 and FIG. 6. FIG. 5 and FIG. 6 are schematic diagrams of the experimental data of an identity recognition method of an embodiment of the invention. Shown as FIG. 5, the present invention gets the best effect when the matching threshold is 25, FAR is 0 and FRR is 0.383%.

Moreover, there are 4 palm vein images from each person, the present invention requires 2 of the images as the database of system, the present invention is able to get 8 rotated palm vein images by rotating the others images through a function through 4 various angles, such as −300 degrees, −150 degrees, 150 degrees and 300 degrees, the total number of the images positive tested by the present invention is 4,000. While the present invention chooses one person as the set of test and the other 499 people as the set of database, the total number of the images negative tested by the present invention is 4,000. Table.2 shows the simulative effect on the recognition rate and the intrusion rate of the palm vein images being rotated. As shown in FIG. 6, there are still 94.07% on the recognition rate and 0 on the intrusion rate after the images are rotated within 30 degrees in the experiment.

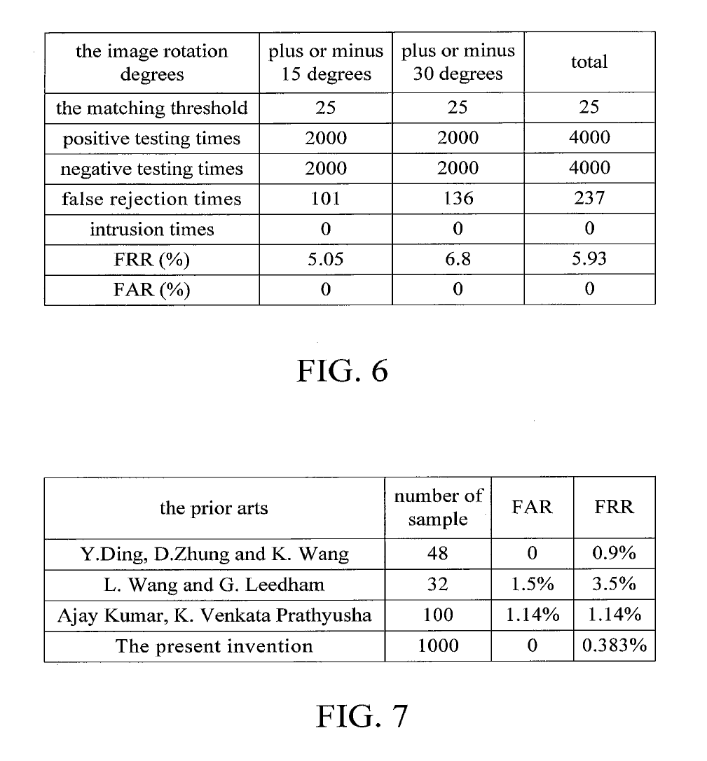

Please refer to FIG. 7. FIG. 7 is a schematic diagram of the comparison between the prior art and the present invention. As shown in FIG. 7, the present invention has a better performance on FAR and FRR than the prior art.

In summary, the present invention discloses an identity recognition method, and particularly emphasizes on a biometric method by palm vein. The method applies a convolution process to the initial image, utilizes Scale Invariant Feature Transformation (SIFT) to transform the captured image to a set of feature points and calculates the similarity through the set of feature points. More particularly, the feature points transformed by SIFT have a considerable resistance to the scale variation and rotation respectively for resisting part of the illuminance variation of image and the interference of noise. And the method of the present invention can have a considerably good recognition.

Although the present invention has been illustrated and described with reference to the preferred embodiment thereof, it should be understood that it is in no way limited to the details of such embodiment but is capable of numerous modifications within the scope of the appended claims.

What is claimed is:

1. An identity recognition method, for recognizing a plurality of biometric features of a predetermined palm by a set of biometric features stored in a database, comprising the following steps of:
(S1) forming an initial image;
(S2) determining if the initial image matches the image of the predetermined palm, if yes, process step (S3);
(S3) applying a convolution process to the initial image;
(S4) capturing a plurality of biometric features from the initial image by Scale Invariant Feature Transformation (SIFT); and
(S6) comparing the plurality of the biometric features of the initial image to the set of biometric features stored in the database.

2. The identity recognition method of claim 1, wherein (S1) comprises the following substeps of:
(S11) irradiating a light of 700 to 1400 nanometer wavelength to the predetermined palm; and
(S12) receiving the light from the predetermined palm and utilizing the light to build the initial image.

3. The identity recognition method of claim 1, wherein (S2) comprises the following substeps of:
(S22) framing a rectangular part from the initial image;
(S24) marking a plurality of scan lines in vertical and horizontal directions within the rectangular part; and
(S26) calculating a plurality of points passed by the plurality of scan lines, wherein each point comprises a gray value, an accumulated value is increased if the gray value is larger than a gray threshold, the initial image is determined to a palm image if the accumulated value satisfies a specific condition.

4. The identity recognition method of claim 1, wherein (S2) further comprises the following substep of:
(S28) reapplying (S1) if the initial image is different from the palm image.

5. The identity recognition method of claim 1, wherein (S3) further comprises the following substep of:
(S32) the convolution process comprises a Gabor filtering process or a Histogram Equalization process.

6. The identity recognition method of claim 1, wherein (S4) further comprises the following substeps of:
(S42) detecting an extremum in a scale space;
(S44) selecting a feature point;
(S46) determining the direction of the feature point; and
(S48) building a describing vector of the feature point.

7. The identity recognition method of claim 6, wherein (S42) further comprises the following substep of:
(S422) applying Gaussian Blur or Difference of Gaussian to the initial image for detecting the extremum of the scale space.

8. The identity recognition method of claim 1, further comprising the following step of:
(S7) determining if a matching value of the plurality of the biometric features of the initial image to the set of biometric features stored in the database is larger than a matching threshold, if yes, recognition succeeds.

9. The identity recognition method of claim 8, after (S7), further comprising the following step of:
(S8) if the matching value of the plurality of the biometric features of the initial image to the set of biometric features stored in the database is not larger than the matching threshold, recognition fails.

10. The identity recognition method of claim 1, wherein the initial image is a palm vein image.
